(19) United States
(12) Patent Application Publication
(10) Pub. No.: US 2006/0216827 A1
(43) Pub. Date: Sep. 28, 2006

(54) Method for controlling a process

(76) Inventors: Kari Pulkkinen, YLIVIESKA (FI); Heikki Laurila, Vihti (FI); Kari Saloheimo, Espoo (FI); Mikko Lyyra, Pori (FI); Seppo Heimala, Pori (FI)

Correspondence Address: MORGAN & FINNEGAN, L.L.P., 3 WORLD FINANCIAL CENTER, NEW YORK, NY, 10281-2101, US

(21) Appl. No.: 10/548,687

(22) PCT Filed: Mar. 10, 2004
(86) PCT No.: PCT/FI04/00129

§ 371 Date: Sep. 9, 2005

(30) Foreign Application Priority Data
Mar. 14, 2003 (FI) 20030381

(51) Int. Cl. G01N 35/00

(52) U.S. Cl. 436/43

(57) ABSTRACT

The invention relates to a method for controlling a process, in which method at least part of the process raw materials are conducted into at least one measuring cell that comprises at least one working electrode and at least one reference electrode. In accordance with the invention, in the measuring cell, there is fed together with the raw material at least one component, and the changes caused by said component in the properties of the raw material are measured by a working electrode and a reference electrode provided in the measuring cell, and that the measurement results are utilized in order to define the composition of the raw material, and by means of the defined raw material composition, the process is controlled in order to eliminate a possible altering effect.

The present invention relates to a method for controlling a process, by which method there is found out the composition of a raw material at a sufficient accuracy in essentially continuous process conditions.

Several different controlling methods are developed for various processes. This applies both to pyrometallurgic and by nature hydrometallurgic processes. A long experience has shown that many controlling methods give a good result, but only as long as the composition of the feed is essentially constant, or otherwise known. As the quality of raw materials becomes more varied, generally weaker, the process adjustments do not remain appropriate anymore. Methods suitable in known processes are either too slow, or then various different crystal forms, solubilities or other physico-chemical factors have prevented a surveillance of the feed quality that is sufficiently accurate and rapid from the point of view of the controlling of the processes and is carried out directly in the process. Among these types of methods, there have been used, for example various methods based on feed content analyses, pH measurements, redox potential measurements and X-ray diffraction, as well as methods using an inert electrode.

Most processes are based on heterogeneous surface reactions. Therefore a very small change directly in the feed quality or indirectly as a result of a change in the feed composition may cause a remarkable change in the process. In solid and molten phases, already a content of a few ppb or ppm of a component can be significant, if the component is concentrated for instance on the surfaces of the particles under treatment.

Likewise, as regards liquid phases in practical process conditions, it has been found out that a process may behave in different ways, if certain ions, molecules or the like are present in the liquid phase, in contents of the order of micrograms per liter (μg/l) or milligrams per liter (mg/l). In slurry, these may be partly present both in the solution phase and simultaneously also as adsorbed on the surfaces of solid phase particles. There can be separately mentioned compounds that are by nature polymeric and/or colloidal and contain silicon, carbon, sulfur, arsenic or selenium, as well as many other compounds formed by elements that react with many different valences. In addition, it is pointed out that the components affecting the controlling of a process are not only obtained from feeds, but often already at the beginning of the process there are circulations were the water used in the process is recirculated. These kinds of circulations together with changes in the feed quality constitute a real challenge owing to their combined non-linear effects, when observing a rapid and accurate derivate control of processes.

For process surveillance, there have been developed more accurate and reliable methods, such as the one described in the CA patent 1,222,581. As an essential factor in said method, there are used active electrodes that are in principle made of the same minerals that the raw material itself contains in the process step under observation. The measurement and controlling method described in the CA patent 1,222,581 is developed further in a way described in the U.S. Pat. No. 5,108,495, where impedance analysis is made use of. In an improved measurement control method according to the U.S. Pat. No. 5,108,495, kinetic factors are integrated in the measurement and process control, and also physical factors in a very specific way, for instance mineral by mineral. The method according to the U.S. Pat. No. 5,108,495 is very informative, sensitive and accurate in several different fields of technology, in the measurement and control of both surface reactions and the reactions and phenomena of liquid phases, molten phases and solid phases. However, the increased fluctuations in the quality of process feed materials have set further requirements for process surveillance and control.

The object of the invention is to eliminate drawbacks of the prior art and to realize an improved method that enables measuring and controlling, by which method there is found out the composition of a raw material at a sufficient accuracy, essentially in continuous operation, in process conditions, for a process where surface reactions constitute the dominant part of the process, such as for example the leaching, precipitation, flotation, sedimentation, filtering and flocculation processes. The essential novel features of the invention are enlisted in the appended claims.

According to the invention, there are measured the effects of various types of raw material in mineral wise potentials and impedance spectrums in the operational range of the process and in the vicinity of said operational range. In this way it is possible to identify the raw material in question, as well as changes occurring in the composition of raw materials and other changes in properties, caused by the changes in composition. At the same time there is found out the size of the range that is available for each ingredient in the process.

In the method according to the invention, for controlling a process there is employed at least one working electrode and at least one reference electrode, for instance of the silver chloride (AgCl) type. The working electrode is made of a solid or pulverous material. The working electrode can also be made of a molten or liquid material. The working electrode can be regenerable, as is described in the CA patent 1,222,581, or disposable, in which case in the electrode there is fed, in a controlled way, new working electrode manufacturing material, such as powder, solid material or liquid, molten material, in which case the working electrode is regenerated by replacing the working electrode material that was consumed in the method by new material.

The working electrode and reference electrode employed in the method according to the invention are arranged in at least one measuring cell, so that each measuring cell includes at least one working electrode and at least one reference electrode. Advantageously the measuring cell is installed either in the process flow proper, or in a sample flow separated from the process flow, which sample flow can be analyzed by means of a separate sample analyzer. In the measuring cell, there is fed raw material meant for the process or for a single process step, and when necessary, also reagents for realizing the process in a advantageous way. In addition, in the measuring cell there is fed a predetermined amount of at least one component, and the changes caused by said component are measured in the measuring cell, in order to define the fluctuations occurring in the raw material meant for the process or for a single process step, and for identifying the composition of the raw material. On the basis of possible fluctuations measured in the raw material, the process is adjusted in order to change the process conditions to a desired level, so that the altering effects can be eliminated. For controlling the process according to the invention, among the measurements required in order to find out the changes occurring in the various properties, there are preferably at least the definition of the acid-base equilibrium as a pH measurement, the measurement of the oxidation-reduction equilibrium by means of the electrochemical potential, as well as the temperature at which the process or a single process step is carried out. Moreover, when necessary, the delay of the material to be processed in the process can be defined as a function of time. Further, in the measurements it is advantageous to pay attention to the complexing reagents either added in the process or created in the process. It is characteristic of complexing reagents that they can have a significant effect on the proceeding of the process even in very small contents that are difficult to detect. In the method according to the invention, in the surveillance of the content and quality of the complexing reagent either created from the raw material or added in the process in order to analyze the raw material quality, there are employed the differences in measurement results obtained by at least two mineral electrodes or inert electrodes.

In order to be able to take into account the fluctuations of raw materials and the effects of these fluctuations in the different properties when controlling the process, it is advantageous that the measurements are at the various measurement points of the process carried out so that for all variables, there is obtained at least one measurement result. Naturally in that case at each single measurement point, the aim is to keep the number of variables as small as possible and still maintain an adequate degree of reliability.

Consequently, the measuring cell used in the method according to the invention, through which measuring cell the raw material is fed in, must include at least one mineral electrode serving as the working electrode, at least one reference electrode as well as preferably electrodes for the electrochemical potential measurement of certain substances, such as collectors and sulfides, when in the measuring cell there is simultaneously fed for example an oxidizer, reductant, acid, base and/or complexing reagent. As for the mineral electrodes as such, they are made of the minerals contained in the desired raw material under observation. Thus, by observing the changes in the potentials and surface structures of the mineral electrodes, as well as the contents of the soluble substances, for instance by defining the areas of the current peaks connected to their reduction or oxidation currents, there can be defined the changes occurring in the desired raw material, which changes are further utilized for controlling the process. When necessary, the measuring cell can naturally be used for observing some other variables according to the prior art, such as electroconductivity, temperature, color changes, pH changes, possible development of gases, changes in viscosity, magnetism and turbidity, changes in the settling rate, electric effects caused by a strong ultrasound as the surface charges move (=electrokinetic phenomena), so-called zeta potential, etc. Moreover, it is possible to perform content measurements for different variables, which means the measurement of the change in pH, electrochemical potential or zeta potential caused in the raw material by a certain reagent quantity as such, or the registration of the time change in the variable. Thus the factors of the feed composition are found out in advance, at a high accuracy and essentially continuously from the supplied raw material. By feeding the obtained information to the connected surveillance and control software, the process can be adjusted in an essentially continuous fashion to optimal conditions with respect to the composition of the raw material.

Advantageously the method according to the invention can be applied in the surveillance of the feed quality for instance in the following processes: leaching, precipitation, flotation, settling, filtering and flocculation. In that case, in the feed flow with a known quantity, there is fed a certain, measurable quantity of acid or base, reductant or oxidizer, complexing reagent. By means of the measuring cell, there is observed the change possibly caused for example in pH, electroconductivity, color, magnetism, electrokinetic potentials, electrochemical potentials, viscosity, solubilities, and gas formation. When there also is utilized mineral wise so-called impedance spectrum surveillance, impedance analysis, the changes occurred in the composition of the material fed in the process are advantageously defined.

Using mineral electrodes together with impedance analysis and other methods enlisted above, the fluctuations of the process feed can be observed directly and continuously in a way that is advantageous for the controlling of the process. At the same time, there is found out the width of the available ranges of the process variables with the process control in question, such as pH and temperature. In a method according to the invention, for defining impedance values from the electrodes there is applied a frequency below 300 Hz, preferably 100 Hz.

By using the method according to the invention, it also is possible to observe the combined effects of the circulating process flows and the fluctuation of the feed quality, and consequently also the fluctuation of the feed quality. The method according to the invention is suited in a large variety of different processes, independent of the applied temperature and pressure. Among others, this means processes applying normal pressure, autoclave processes, molten salt processes and pyrometallurgical processes.

The method according to the invention is described below with reference to the appended example, in which example there was selected hydrated nickel sulfide ore, a common occurrence in the world.

The appended example is further illustrated by a drawing, where

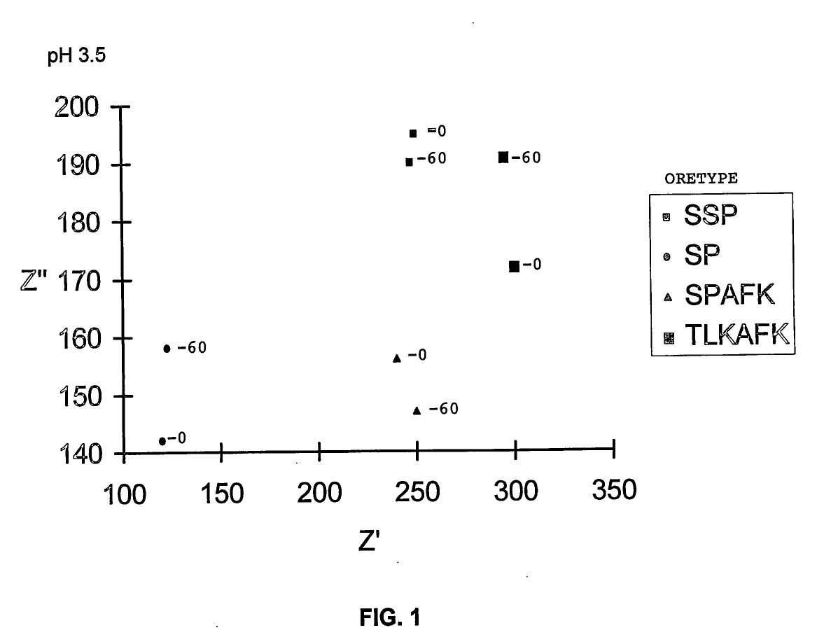

FIG. 1 illustrates the values enlisted in the table 1 of the example for various types of ores in a Z′-Z″ coordinate system, where the initial pH value is 3.5.

When the technology according to the method was applied to defining the various ore types of this nickel ore, there were obtained results that are added in table 1. The change effect according to the invention was caused by sulfuric acid and reductant hydrogen sulfide. In table 1, Z′, Z″ and ΔR refer to the resistance values in ohms, obtained in an impedance analysis with a NiS based mineral electrode from the raw material slurry by applying a 5 mV pulse and a 10 Hz frequency. Here Z′ refers to the real part, and Z″ refers to the imaginary parts connected to capacitance and inductance. The reaction resistance (Z′_{low frequency}−Z′_{high frequency}) according to the method of the surface of the NiS based mineral electrodes is in the table 1 marked by ΔR, the unit whereof is an ohm. The unit of the electrochemical potential E of the NiS based mineral electrodes in the table 1 is mV, when measured with an AgCl/Ag reference electrode.

TABLE 1

| | | Ore type | | | | | | | | | |
|---|---|---|---|---|---|---|---|---|---|---|---|
| Initial | | SPAFK | | | | | TLKAFK | | | | |
| pH | NaHS | | | | | Final | | | | | Final |
| − | 50 mg/l | Z′ | Z″ | E | ΔR | pH | Z′ | Z″ | E | ΔR | pH |
| 6 | − | 516 | 224 | −340 | 121 | 6.18 | 664 | 357 | −60 | 246 | 6.28 |
| | + | 502 | 227 | −150 | 127 | 6.03 | 586 | 259 | −180 | 188 | 6.17 |
| 5 | − | 333 | 165 | −320 | 82 | 5.33 | 416 | 181 | −270 | 96 | 5.40 |
| | + | 405 | 203 | −180 | 116 | 5.47 | 386 | 224 | −220 | 123 | 5.35 |
| 4 | − | 298 | 177 | −270 | 89 | 4.82 | 308 | 213 | −250 | 95 | 4.58 |
| | + | 322 | 185 | −210 | 102 | 4.98 | 315 | 192 | −220 | 123 | 4.94 |
| 3.5 | − | 243 | 157 | −260 | 83 | 4.13 | 301 | 171 | −240 | 105 | 4.20 |
| | + | 253 | 147 | −220 | 80 | 4.21 | 295 | 191 | −230 | 109 | 4.17 |
| | | serpentine amphibole | | | | | talcum amphibole | | | | |
| | | Ore type | | | | | | | | | |
| Initial | | east ore | | | | | center pillar | | | | |
| pH | NaHS | | | | | Final | | | | | Final |
| − | 50 mg/l | Z′ | Z″ | E | ΔR | pH | Z′ | Z″ | E | ΔR | pH |
| 6 | − | 553 | 254 | −170 | 148 | 6.19 | 265 | 244 | −30 | 114 | 6.09 |
| | + | 599 | 304 | −140 | 172 | 6.06 | 243 | 233 | −100 | 99 | 6.12 |
| 5 | − | 377 | 208 | −170 | 114 | 5.46 | 189 | 189 | −100 | 70 | 5.47 |
| | + | 391 | 276 | −200 | 115 | 5.38 | 187 | 190 | 140 | 77 | 5.49 |
| 4 | − | 302 | 188 | −200 | 99 | 4.92 | 147 | 179 | −20 | 57 | 4.83 |
| | + | 292 | 191 | −200 | 91 | 4.82 | 148 | 185 | −60 | 65 | 4.33 |
| 3.5 | − | 251 | 195 | −160 | 94 | 4.47 | 118 | 142 | +120 | 47 | 4.41 |
| | + | 246 | 190 | −190 | 90 | 4.32 | 122 | 159 | +50 | 64 | 4.52 |

| | |
|---|---|
| sulfidic serpentine | serpentine |

Table 1 illustrates the obtained results for four different types of ore: serpentine amphibole (SPAFK), talcum amphibole (TLKAFK), sulfidic serpentine (SSP) and serpentine (SP). The above mentioned values (Z′, Z″, ΔR and E) are measured with different pH values 3, 5, 4, 5 and 6, when only sulfuric acid (−) is added in the slurry, and when also sodium hydrogen sulfide (NaHS) (+) is added in the slurry. Moreover, in table 1 there also is given the pH value after each measurement.

When using, as an indicator, only the consumption of neutral acid as a function of the pH, it is possible to identify the SP ore type of the ore in question, but not other ore types present in the ore. On the other hand, when applying impedance analysis (Z′, Z″, ΔR) and potential measurement of the mineral electrodes according to the invention, in a way illustrated by the table, and by causing a change in the raw material by sulfuric acid and a reagent affecting the oxidation-reduction equilibrium, i.e. sodium hydrogen sulfide (NaHS), all ore types present in the hydrated nickel sulfide ore of the example can be distinguished from each other. Further differences are created by using other measurable quantities according to the method. In table 1 it is seen that the lowest value Z′ is obtained with the SP ore type of the ore, and the highest value is obtained with the TLKAFK ore type. Although appropriate multivariable software must be used in the raw material identification required for the controlling of the process, the results illustrated in table 1, i.e. the differences obtained for various ore types, can in this case also be illustrated by two-dimensional representations, one example of which is the appended FIG. 1.

In FIG. 1, different ore types are arranged as separate groups in the Z′-Z″ coordinate system both when using only sulfuric acid and also when adding sodium hydrogen sulfide, NaHS, when the initial pH is 3.5. It is understandable that in different processes and with different raw materials, the most effective indicators of identification data in the method according to the invention are various minerals in various different combinations, together with other measurable variables. In connection with the hydrated ore dealt with in the example, one of the most natural minerals is NiS. However, as an indicator of the created differences, a mineral of the Ni₃S₄ type is more effective.

1. A method for controlling a process, in which method at least part of the process raw materials are conducted into at least one measuring cell that comprises at least one working electrode and at least one reference electrode, wherein in the measuring cell, there is fed together with the raw material at least one component, and the changes caused by said component in the properties of the raw material are measured by a working electrode and a reference electrode provided in the measuring cell, and that the measurement results are utilized in order to define the composition of the raw material, and by means of the defined raw material composition, the process is controlled in order to eliminate a possible altering effect.

2. A method according to claim 1, wherein the feeding of the component in the measuring cell together with the raw material is carried out essentially in a continuous operation.

3. A method according to claim 1 wherein the feeding of the component is utilized in defining the acid-base equilibrium as a pH measurement.

4. A method according to claim 1 wherein the feeding of the component is utilized in measuring oxidation-reduction equilibrium by means of electrochemical potential.

5. A method according to claim 1, wherein as the working electrode of the measuring cell, there is employed an electrode made of mineral.

6. A method according to claim 5, wherein the working electrode is made of a mineral resembling the raw material under observation.

7. A method according to claim 1, wherein the working electrode of the measuring cell is used for performing an impedance analysis.

8. A method according to claim 1, wherein in the surveillance of the content of the complexing reagent added for the benefit of the analysis and created of the raw material to be fed in the process, there are utilized the differences of the measuring results obtained with at least two mineral electrodes.

9. A method according to claim 1, wherein the feeding of the component is carried out to a measuring cell installed in the process flow.

10. A method according to claim 1, wherein the feeding of the component is carried out to a measuring cell installed in a sample flow separated from the process flow.
